(19) United States
(12) Patent Application Publication
(10) Pub. No.: US 2025/0168700 A1
(43) Pub. Date: May 22, 2025

(54) PRE-COMPENSATION OF PDU SET SIZE VALUE FOR TRANSPORTING MEDIA DATA VIA A NETWORK

(71) Applicant: QUALCOMM Incorporated, San Diego, CA (US)

(72) Inventors: Liangping Ma, San Diego, CA (US); Sebastian Speicher, Wallisellen (CH); Imed Bouazizi, Celina, TX (US); Nikolai Konrad Leung, San Francisco, CA (US)

(21) Appl. No.: 18/947,981

(22) Filed: Nov. 14, 2024

Related U.S. Application Data
(60) Provisional application No. 63/599,930, filed on Nov. 16, 2023.
(60) Provisional application No. 63/717,667, filed on Nov. 7, 2024.

(51) Int. Cl. H04W 28/06

(52) U.S. Cl. CPC H04W 28/06

(57) ABSTRACT

An example device for retrieving media data includes: a memory configured to store media data; and a processing system implemented in circuitry, the processing system being configured to: calculate a cumulative size of packets of a protocol data unit (PDU) Set received from a source device; determine a signaled size for the PDU Set; calculate a ratio between the cumulative size and the signaled size; and send data representative of the ratio to the source device.

This application claims the benefit of U.S. Provisional Application No. 63/599,930, filed Nov. 16, 2023, and of U.S. Provisional Application No. 63/717,667, filed Nov. 7, 2024, the entire contents of each of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging media data. In particular, when exchanging media data via a network, media data may be grouped into protocol data unit (PDU) Sets. Each PDU Set may correspond to a group of network packets, such as IP packets. IP packets may become fragmented, and various networks support various IP address types, e.g., IPv4 vs. IPv6. The routers in the middle of the end-to-end path may add additional packet headers, e.g., segment routing header (SRH). A PDU Set size value may be sent to indicate the amount of expected data for a PDU Set, such that a destination device can properly recover the data (e.g., perform IP reassembly).

However, changes to IP address types as packets traverse a network, IP fragmentation, and segment routing, may lead to the PDU Set size for a PDU Set being inaccurate a router, e.g., the base station in a cellular network, which results in a waste of resources or insufficient resources in resource allocation. This disclosure describes techniques by which a sending device may pre-compensate for such issues by altering a calculated PDU Set size. For example, the destination device may send an indicator, e.g., a ratio value representing a ratio of actual PDU Set size to the signaled PDU Set size, and the source device may multiply its calculated PDU Set size by the ratio to compute a new signaled PDU Set size for a subsequent PDU Set.

Additionally or alternatively, the destination device and/or a device along the network path between the destination device and the source device may determine whether the IP address type(s) are different between the source device and the router that does resource allocation. The source device may then pre-compensate the PDU Set size according to these IP address type differences, e.g., to account for differences in IP address header sizes between different IP address types.

In one example, a method of exchanging media data includes: calculating a cumulative size of packets of a protocol data unit (PDU) Set received from a source device; determining a signaled size for the PDU Set; calculating a ratio between the cumulative size and the signaled size; and sending data representative of the ratio to the source device.

In another example, a device for retrieving media data includes: a memory configured to store media data; and a processing system implemented in circuitry, the processing system being configured to: calculate a cumulative size of packets of a protocol data unit (PDU) Set received from a source device; determine a signaled size for the PDU Set; calculate a ratio between the cumulative size and the signaled size; and send data representative of the ratio to the source device.

In another example, a computer-readable storage medium has stored thereon instructions that, when executed, cause a processing system to: calculate a cumulative size of packets of a protocol data unit (PDU) Set received from a source device; determine a signaled size for the PDU Set; calculate a ratio between the cumulative size and the signaled size; and send data representative of the ratio to the source device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for exchanging media data over a network.

FIG. 2 is a block diagram illustrating elements of an example video file.

FIG. 3 is a flow diagram illustrating an example method for exchanging media data according to techniques of this disclosure.

FIG. 4 is a flow diagram illustrating another example method for exchanging media data according to techniques of this disclosure.

FIG. 5 is a flow diagram illustrating another example method for exchanging media data according to techniques of this disclosure.

FIG. 6 is a flow diagram illustrating another example method for exchanging media data according to techniques of this disclosure.

FIG. 7 is a flowchart illustrating an example method that may be performed by a user equipment (UE) device while participating in a media communication session according to techniques of this disclosure.

### DETAILED DESCRIPTION

In general, this disclosure describes techniques for exchanging media data via a network. The network may be a 5G network, a 6G network, or other radio access network (RAN). A protocol data unit (PDU) set represents one or more PDUs each carrying a payload of a unit of information generated at the application level. Thus, for example, a PDU may include a frame of video data, a slice of a frame of video data, audio data, computer graphics data, or other media data for an extended reality (XR) service. 3GPP TS23.501 v.18.1.0 includes this definition of a PDU Set.

When two (or more) devices are engaged in an XR session, one device may send a PDU Set size to another device, where the PDU Set size may represent the total size of all PDUs of the PDU Set to which a particular PDU belongs, including RTP/UDP/IP header encapsulation overhead of the corresponding PDUs. An RTP (real-time transport protocol) sender may compute the PDU Set size value (PSSize) and include the PSSize value in an RTP header extension of an RTP packet sent to the RTP receiver. For example, the RTP sender may include the PSSize value in a GPRS Tunneling Protocol User Plane (GTP-U) packet header during GTP-U encapsulation at a user plane function (UPF), which may aid resource allocation for over-the-air transmissions. The PSSize value may include the size of the IP packet header and other packet headers.

However, the IP address version (e.g., IPv4 or IPv6) used by the RTP sender locally to generate the IP packets encapsulating the RTP (and/or, in some cases, UDP (user datagram protocol)) packets may be different from the IP version sent to a user plane function (UPF) device, due to network tunneling (e.g., IPv4-v6 tunneling, carrier grade network address translation (CGNAT), or network address translation-protocol translation (NAT-PT)), IP fragmentation or other such issues. Thus, the initially calculated PSSize value may have errors due to, for example, network operations that may change the PSSize and the traffic source may not be configured with the information indicative of such operations.

In 3GPP SA2/SA4, a source device generates a PDU Set Size (PSSize) value and adds the PSSize value to an RTP header extension of RTP packets carrying media data of the PDU Set. In this manner, the information may be passed via a router (which may execute a user plane function (UPF)) to a radio access network (RAN) to which a destination device is communicatively coupled, for scheduling over-the-air transmissions. The PSSize value may take account of sizes of IP packet headers, which may vary based on IP packet type (e.g., IPv4 uses IP packet headers of 20 bytes, whereas IPv6 uses IP packet headers of 40 bytes).

Certain issues may arise along a network route/path that may render a calculated PSSize value inaccurate. For example, network address translation (NAT), e.g., per NAT46/NAT64, and IP fragmentation may cause changes to received packets that render the initially calculated PSSize value inaccurate at the destination device. In NAT46, for example, an incoming IP packet with IPv4 address is converted to an IP packet with IPv6 address, which results in a change in the total packet size because of the difference in the size of the IP packet header between IPv4 and IPv6. NAT64 is effectively the same issue in reverse.

Other operations that may result in PSSize value inaccuracies include IP fragmentation, where each increment in the number of IP packets adds an additional size worth of an IP packet header to the PSSize value, and TURN, where the TURN server may add a STUN message header, a STUN attribute, and a transport address. There are other such operations as well, and more operations may be developed in the future that alter the PSSize value.

Some techniques aiming to address these issues focus on using an application function (AF) to solve the NAT46/NAT64 issues. In such techniques, the AF detects the use of NAT46/NAT64 at the source and signals the use to UPF which then corrects the PSSize by adjusting the PSSize extracted from the passing RTP packets. However, these techniques do not address IP fragmentation issues, nor segment routing issues. In segment routing (e.g., over MPLS or IPv6), an ingress router may add a segment routing header to an incoming packet and send out a packet with an increased total packet header size.

This disclosure recognizes that case by case approaches may not be complete, even if an IP fragmentation issue solution is found because the implementation of Internet protocols and the deployment of routers on the Internet is diverse and continues to evolve. Furthermore, the case by case approaches may miss other existing issues or fail to anticipate issues arising in future Internet developments. Techniques requiring additional processing in a router could be expensive to implement.

Thus, the techniques of this disclosure include an end-to-end measurement-based pre-compensation approach and an IP version signaling approach. The end-to-end measurement-based pre-compensation approach is generic, without needing to determine the causes of PSSize mismatches; does not require additional processing by network routers, and is applicable to both cellular systems and non-cellular systems, such as Wi-Fi.

This disclosure describes techniques to resolve such issues, including signaling a correction ratio, which may be calculated by the client device as the actual received PSSize value to the indicated PSSize value. The actual received PSSize value may be observed by the client/receiver device (e.g., a user equipment (UE) device), including the size of the media and various packet headers (e.g., of IP, UDP, RTP, and QUIC). The indicated PSSize is the PSSize carried in the RTP header extension for the PDU Set.

This disclosure further describes techniques by which the ratio may be signaled. For example, the ratio may be signaled in a session description protocol (SDP) message. This disclosure describes techniques relating to how the SDP message can be sent, how to use a Simple WebRTC Application Protocol (SWAP) “application” message to indicate the error with a reduced message size, and a new SWAP message. SWAP is described in, e.g., TS 26.113 v18.1.0, “3rd Generation Partnership Project; Technical Specification Group Services and System Aspects; Real-Time Media Communication; Protocols and APIs (Release 18)” (2024-09), available at portal.3gpp.org/desktopmodules/Specifications/SpecificationDetails.aspx?specificationId=4041.

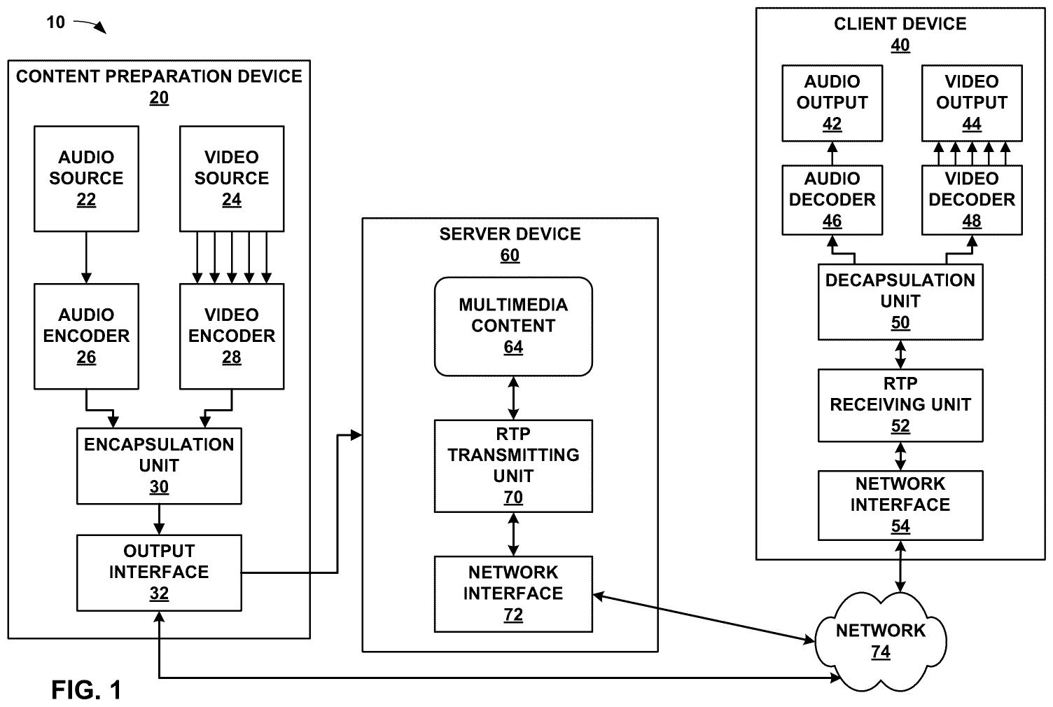

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Server device 60 may initially determine a PDU Set size (PSSize) value for a PDU Set, e.g., based on a number of packets included in the PDU Set, IP, UDP, and RTP header sizes for each of the packets, payload sizes for the packets, and so on. RTP transmitting unit 70 may signal the PSSize value in an RTP extension header of packets for the PDU Set.

Network interface 54 may include additional sub-units (not shown in FIG. 1). For example, network interface 54 may include sub-units for processing each layer of the OSI Network Model, e.g., layer 1, layer 2, layer 3, and so on. A unit at layer 3 (the transport layer) may be configured to perform certain techniques of this disclosure. For example, the unit at layer 3 (referred to hereafter as the “Layer 3 unit”) may receive packets of a Protocol Data Unit (PDU) Set. Prior to performing IP packet reassembly if the packets are fragmented, the Layer 3 unit may calculate a total cumulative size of IP packets belonging to a common PDU set. This total cumulative size may be denoted PSSize_actual. The Layer 3 unit may also extract the signaled PSSize of the PDU Set, which may be denoted PSSize_signaled. The Layer 3 unit may then calculate a ratio for the PDU Set, e.g., ratio (r)=PSSize_actual/PSSize_signaled. The Layer 3 unit may calculate such ratios for all or a subset of the PDU Sets of a media session. If packet loss occurs, the Layer 3 unit many be configured to calculate ratios only for PDU Sets whose packets are completely received.

The Layer 3 unit may pass the ratio to the application layer (e.g., a Media Session Handler (MSH), not shown in FIG. 1), to the RTP layer (handled by RTP receiving unit 52). RTP receiving unit 52 may then compare the ratio to a threshold or range (which may have been advertised/signaled in an RTP extension header or in media session configuration information). The range may be, for example [−0.95, +1.05]. If the ratio exceeds the threshold or is outside of the range, RTP receiving unit 52 may signal the ratio to server device 60 and/or content preparation device 20. For example, RTP receiving unit 52 may send a session description protocol (SDP) update message indicative of the ratio.

When server device 60 receives data representing such a ratio from client device 40, server device 60 may update the signaled PSSize value for a subsequent PDU Set according to the ratio. For example, if server device 60 calculates a new PSSize value for the subsequent PDU Set by the same method as was previously used to calculate the previous PSSize value, server device 60 may then update the new PSSize value according to the received ratio value. For example, if the new PSSize value is p and the ratio is r, server device 60 may update the new PSSize value to be equal to p*r. Thus, receipt of a ratio value may trigger pre-compensation by server device 60 in this manner. That is, pre-compensation may be computation of an updated PSSize value using the ratio value received from client device 40.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

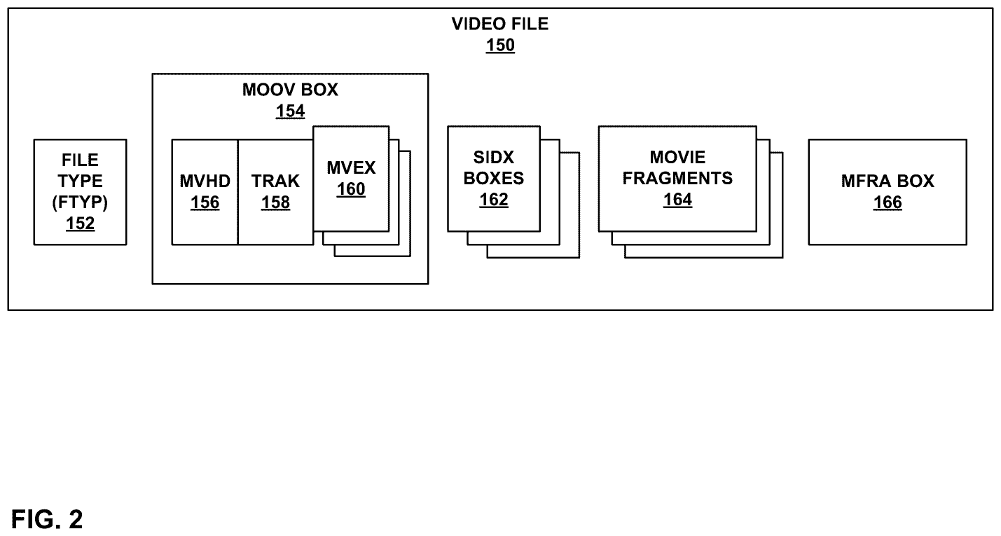

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

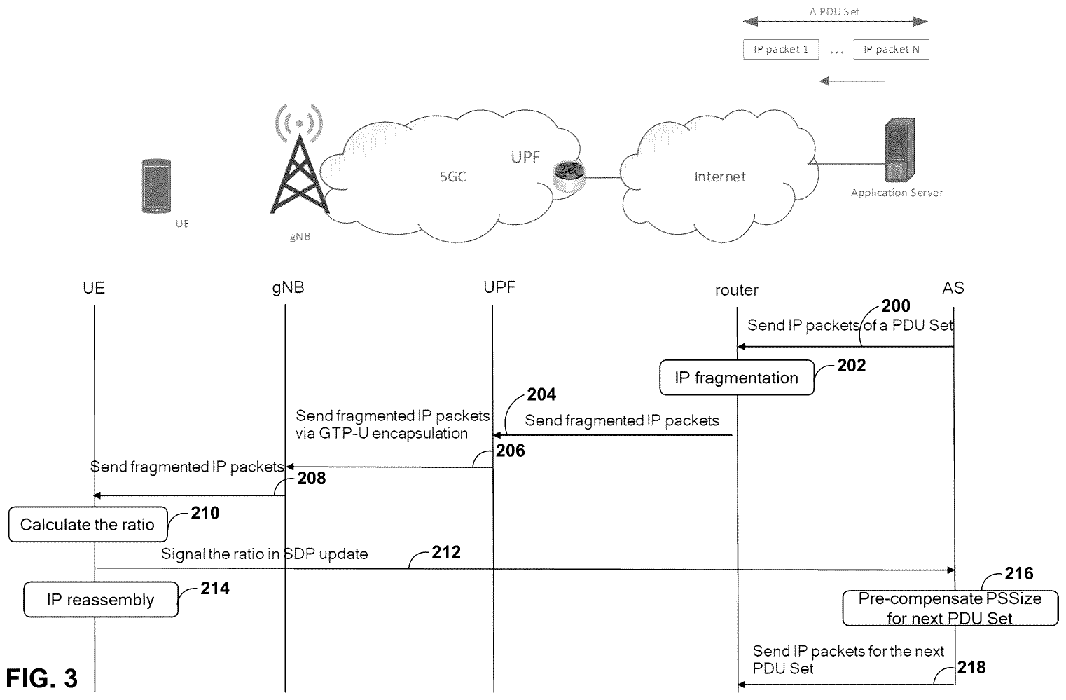

FIG. 3 is a flow diagram illustrating an example method for exchanging media data according to techniques of this disclosure. In this example, initially, an application server (AS), which may correspond to server device 60 of FIG. 1, determines a PSSize value for a PDU Set including one or more packets of media data. The AS may then send the packets of the PDU Set (200).

A router along a network path may receive the packets and perform IP fragmentation (202), e.g., when a maximum transmission unit (MTU) size of a network link does not support sizes of the packets. While FIG. 3 depicts “IP fragmentation” as an operation that modifies the PSSize value for a PDU Set, additional or alternative operations may also be performed, such as NAT46/NAT64, TURN, or the like. The router sends the fragmented IP packets to a user plane function (UPF) device (204). The UPF device encapsulates the fragmented packets using, e.g., GTP-U encapsulation. The UPF device then sends the encapsulated, fragmented packets to a base station, such as a gNB (206).

The gNB decapsulates the packets and allocates resources (e.g., time, frequency, and/or spatial domain resources) for the PDU Set based on the PSSize carried in the RTP headers of the RTP packets that carry the PDUs of the PDU Set. The gNB then sends the fragmented packets to the UE (e.g., client device 40 of FIG. 1) (208).

The UE receives the packets from the gNB. The UE may then calculate how to adjust the PSSize, for example, by calculating a ratio of the cumulative actual size of the received packets for the PDU Set to the advertised PSSize value for the PDU Set (210). If necessary, the UE indicates how to adjust the PSSize, for example, by signaling the ratio to the AS (212), e.g., in an SDP update message. The UE may then perform IP reassembly of the fragmented packets (214), and proceed to process the packets for presentation (e.g., extract the RTP packets, and RTP payload, decode and render the media data in the payload).

In some examples, the UE or other receiving endpoint (which receives a first PDU Set) indicates the PSSize correction ratio via an SDP update (e.g., an SDP Offer). The UE may send the SDP update as part of a SIP re-INVITE message, which is an INVITE message sent after session setup. The transmitting endpoint (which transmitted the first PDU Set) may reply with an acknowledgement, e.g., a SIP 200 OK message, which carries an SDP Answer message.

Alternatively, the UE or other receiving endpoint may send a SWAP message, e.g., with message type “update” or “connect.” The transmitting endpoint may reply with an acknowledgement, e.g., with message type “accept” and carrying an SDP Answer message.

As still another example, the UE or other receiving endpoint may pass an SDP offer message to a JavaScript Session Establishment Protocol (JSEP) running on the UE or other receiving endpoint, and JSEP may communicates the SDP offer message to the transmitting endpoint. In response to the JSEP message, the transmitting endpoint may generate an SDP answer message and pass it to its JSEP which then communicates the SDP answer message to the UE or other receiving endpoint.

As still another example, the receiving endpoint may indicate the PSSize correction ratio using a SWAP message with message type “application.” The SWAP “application” message may include a target parameter that indicates the identifier (ID) of the endpoint that transmitted the first PDU Set. The SWAP “application” message may also include a type value, e.g., “3gpp-release19-PSSize-correction-ratio.” The SWAP “application” message may further include a value for the ratio expressed as a fractional value, e.g., 1.02. The transmitting endpoint may reply with an acknowledgement using a SWAP message with message type “application.” The SWAP “application” message may include a target parameter indicating the ID of the endpoint that sent the PSSize correction ratio and a type value, e.g., “3gpp-release19-PSSize-correction-ratio-ack.” The SWAP “application” message may have a reduced message size compared to the SDP update message, because when an SDP message is used, information needs to be resent for each media stream (identified by an “m=” line), even if the media stream corresponding to that m=line has not changed.

As yet another example, the PSSize correction ratio may be indicated by a dedicated SWAP message type. The new message type (e.g., “PSSizeCorrection”) may be dedicated to signaling the PSSize correction ratio. The receiving endpoint (which receives the first PDU Set) may indicate the PSSize correction ratio using a SWAP message with message type “PSSizeCorrection.” The SWAP message may include a target parameter value indicating an identifier (ID) of the endpoint that transmitted the first PDU Set and a ratio value expressed as a fractional value, e.g., 1.02. The transmitting endpoint (which transmitted the first PDU Set) may reply with an acknowledgement using a SWAP message with message type “PSSizeCorrectionAck.” This message may include a target value indicating the ID of the endpoint that sent the PSSize correction ratio.

In response to receiving the PSSize adjustment indicator (e.g., in an SDP update message or in a SWAP message), the AS may perform pre-compensation for a subsequent PDU Set (216). That is, per techniques of this disclosure, the AS may calculate an initial PDU Set size for the PDU Set, then multiply the initial PDU Set Size by the ratio to form a new advertised PDU Set size for the PDU Set. The AS may then signal the new advertised PDU Set size in an RTP header extension for the PDU Set, and send IP packets for the PDU Set to the UE via the router (218) including the new advertised PDU Set size, as discussed above.

In this manner, the method of FIG. 3 represents an example of a method of exchanging media data including: calculating a cumulative size of packets of a protocol data unit (PDU) Set received from a source device; determining a signaled size for the PDU Set; calculating a ratio between the cumulative size and the signaled size; and sending data representative of the ratio to the source device.

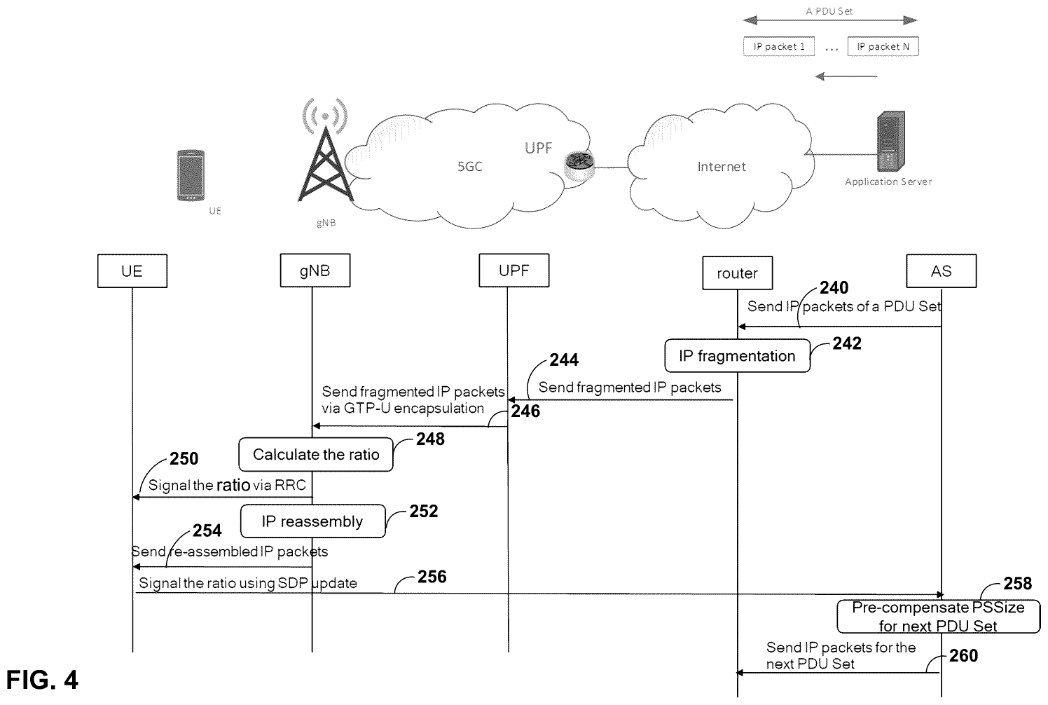

FIG. 4 is a flow diagram illustrating another example method for exchanging media data according to techniques of this disclosure. In this example, it is assumed that the last access network node (e.g., a base station, such as a gNB, or a Wi-Fi access point) performs IP reassembly for fragmented packets. As in the example of FIG. 3, initially, an application server (AS), which may correspond to server device 60 of FIG. 1, determines a PSSize value for a PDU Set including one or more packets of media data. The AS then sends the packets of the PDU Set (240).

A router along a network path may receive the packets and perform IP fragmentation (242), e.g., when a maximum transmission unit (MTU) size of a network link does not support sizes of the packets. The router sends the fragmented IP packets to a user plane function (UPF) device (244). The UPF device encapsulates the fragmented packets using, e.g., GTP-U encapsulation. The UPF device then sends the encapsulated, fragmented packets to a base station, such as a gNB (246).

However, as noted above, in the example of FIG. 4, the gNB performs IP reassembly for fragmented packets. Thus, in the example of FIG. 4, the gNB receives fragmented packets of a PDU Set having a signaled PSSize value and sent by an AS device. The gNB, in this example, calculates the cumulative size for the packets, and calculates the ratio of the cumulative size to the signaled PSSize value (248). The gNB then sends the ratio value to the UE, e.g., via a radio resource control (RRC) message, MAC CE, or DCI (250). The gNB also reassembles the IP packets (252) and sends the reassembled packets to the UE (254).

The UE may then determine whether to send the ratio value to the AS, e.g., based on whether the ratio value is outside of a predetermined range or exceeds a threshold. Assuming the UE determines to send the ratio, the UE signals the ratio value to the AS, e.g., using an SDP update message (256). The AS may then pre-compensate the PSSize value for a subsequent PDU Set (258) and send IP packets for the next PDU Set signaling the pre-compensated PSSize value (260).

In some examples, the gNB may perform the same procedure on multiple PDU Sets (e.g., every PDU Set or a subset of all of the PDU Sets in a QoS flow). Rather than calculating a unique ratio, the gNB may calculate a cumulative average ratio and send the current cumulative average ratio to the UE. In the case of packet loss, the gNB may perform the ratio calculation only for PDU Sets for which all packets are received. In some examples, the gNB may send the ratio value to the UE using, for cellular networks, one or more of a radio resource control (RRC) message, a MAC control element (MAC CE) message, or a downlink control information (DCI) message, or in the case of Wi-Fi, an 802.11 MAC layer management message.

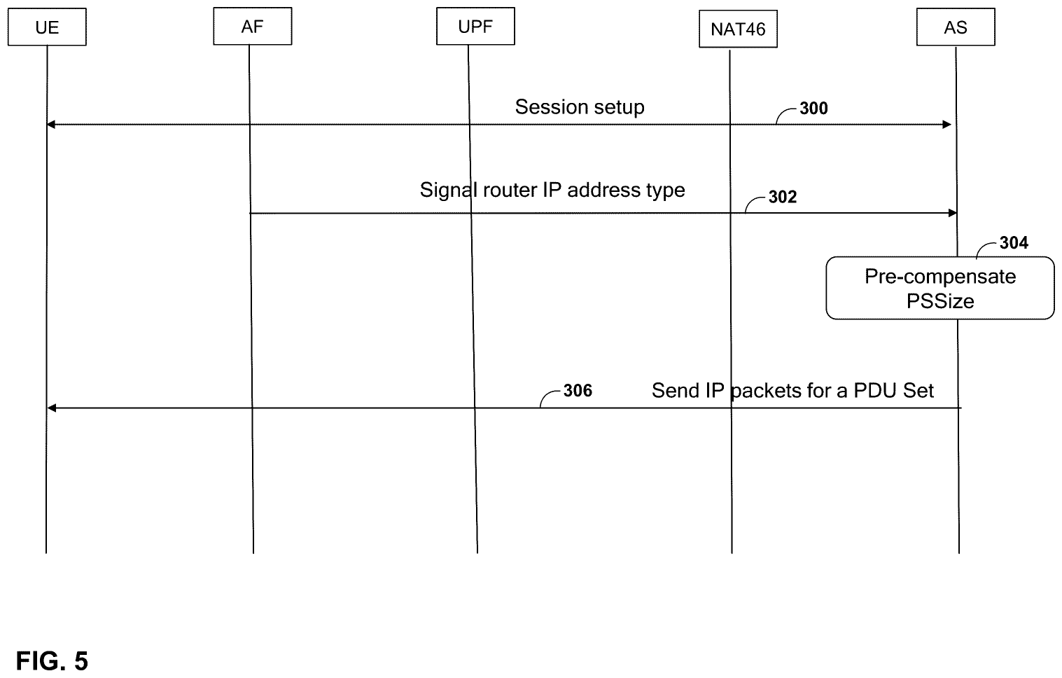

FIG. 5 is a flow diagram illustrating another example method for exchanging media data according to techniques of this disclosure. These techniques may be used where no IP fragmentation is performed. In this example, after establishing a communication session (300) between an application server (AS) and a user equipment (UE) device, an application function (AF) for the UE device signals a router IP address type for a network of the UE to the AS device (302). The router IP address type refers to the type of the IP address for a router which does resource allocation. For example, the router IP address type may be IPv4 or IPv6. In some example, the AS device may obtain the router IP address type during the establishment of the communication session. In some example, the router IP address type is the same as the IP address type of the destination device.

The AS device may then pre-compensate the PSSize value according to the IP address types for the router and the UE (304). For example, the AS device may determine the router IP address type. The AS device may then calculate a signaled PSSize value that is equal to a calculated PSSize value+N*((header size of router IP address type)−(header size of local IP address type at the source device)). If the router IP address type is IPv4, then the header size of router IP address type may be 20 bytes. If the router IP address type is IPv6, then the header size may be 40 bytes. If the local IP address type at the source device is IPv4, then the header size of the local IP address type at the source device may be 20 bytes. If the local IP address type at the source device is IPv6, then the header size may be 40 bytes. N represents the number of PDUs (e.g., IP packets) for the PDU Set. The AS device may then send IP packets for the PDU Set including the compensated PSSize value (306).

Thus, per the method of FIG. 5, an entity (such as the AF device or the UE itself) may obtain the IP address type that is seen by a router in the network (denoted router IP address type) in the packets from a sender (e.g., the AS device). The entity may determine the router IP address type from an IP 5-tupe of {source device IP address, destination device IP address, source port, destination port, protocol} in the QoS setup. An example of the router may be a User Plane Function (UPF). The sender may be an AS device or another end device (e.g., a phone on a Wi-Fi network). The IP address type seen by the UPF may be the same IP address type seen by the UE/destination device. The UE may obtain the router IP address from the AF. The UPF may signal the IP address type it determines in passing RTP packets to the SMF, which may then be forwarded to a core network (e.g., a policy and charging function (PCF) device and/or a session management function (SMF)).

The entity may signal the IP address type to the AS device. If the entity is the AF device and the sender is the AS device, the signaling may be from the AF device to the AS device directly. The signaling may be based on an SDP offer/answer between the receiver and the sender.

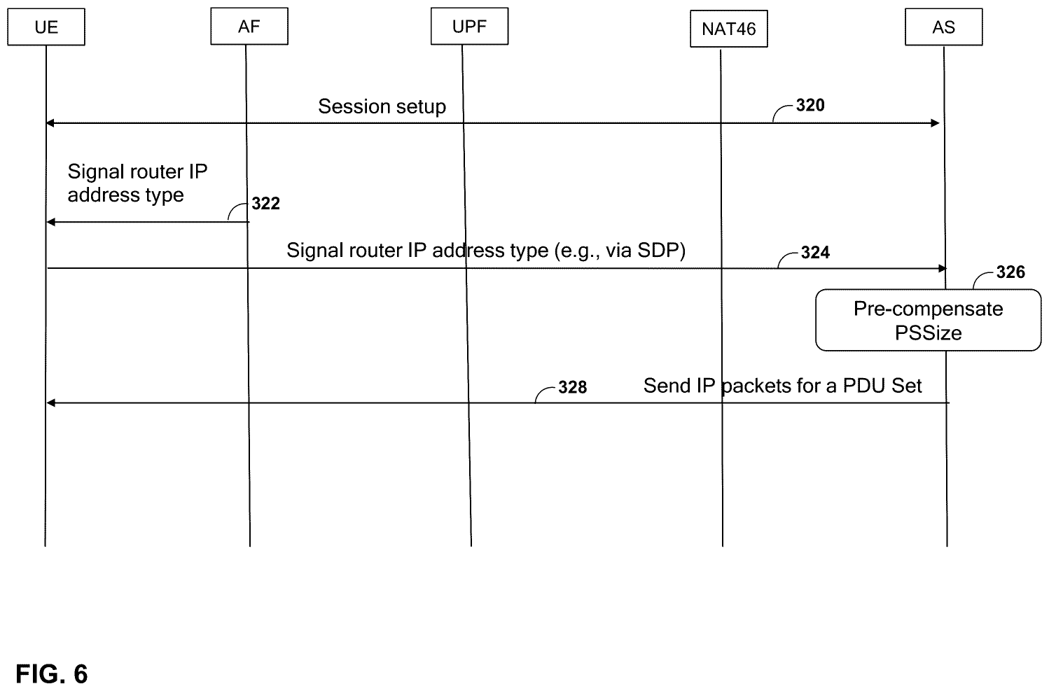

FIG. 6 is a flow diagram illustrating another example method for exchanging media data according to techniques of this disclosure. The method of FIG. 6 is similar to that of FIG. 5, except in this case, the AF device sends the router IP address type to the UE, which prompts the UE to signal the router IP address type (e.g., via SDP) to the AS device. Thus, rather than the AF device sending the router IP address type to the AS device directly, the AF device may send the router IP address type to the UE to cause the UE to send the router IP address type to the AS device.

That is, in the example of FIG. 6, the UE device and the AS device establish a communication session (320). The AF device may send data signaling a router IP address type to the UE device (322). This may cause the UE device to signal the indicated router IP address type to the AS device (324), e.g., via an SDP message. Based on the router IP address type, the AS device may pre-compensate the PSSize value (326). The router IP address type may be, for example, one of IPv4 or IPv6. The AS device may then send IP packets of a PDU Set including data indicative of the compensated PSSize value to the UE device (328).

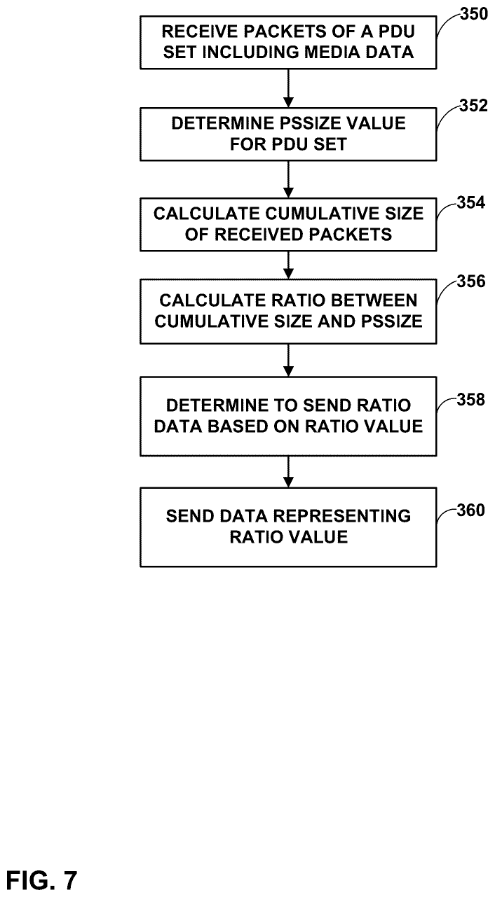

FIG. 7 is a flowchart illustrating an example method that may be performed by a user equipment (UE) device while participating in a media communication session according to techniques of this disclosure. Initially, after having established the media communication session, the UE device receives packets of a PDU Set including media data (350). The packets of the PDU Set may include an RTP header extension signaling a PDU Set Size (PSSize) value for the PDU Set. Thus, the UE device may determine the PSSize value for the PDU Set (352).

The UE device may also calculate a cumulative size of the received packets of the PDU Set (354). Variations in the cumulative size relative to the signaled PSSize value may result due to IP packet fragmentation and reassembly in the network. Thus, the UE device may calculate a ratio between the cumulative size and the signaled PSSize value (356).

The UE device may determine whether to send ratio data based on the ratio value (358). For example, the UE device may receive one or more threshold values for the ratio value from an application server (AS) device. In one example, the UE device may receive an upper bound ratio value, and if the calculated ratio value exceeds the upper bound ratio value, the UE device may determine to send data representative of the ratio to the AS device. In another example, the UE device may receive an upper bound and a lower bound defining a range for the ratio value, and if the calculated ratio value is outside of the defined range (e.g., above the upper bound or below the lower bound), the UE device may determine to send the data representing the ratio value to the AS device.

It is assumed that the UE device determines to send the data representing the ratio value in the example of FIG. 7. Thus, in response to the determination, the UE device sends data representing the ratio value (360). For example, the UE device may send the ratio value itself to the AS device, e.g., in an SDP message. As another example, the UE device may calculate an offset between the cumulative size value and the PSSize value (or a target ratio between the cumulative size and the PSSize value) and signal the offset value to the AS device in the SDP.

In this manner, the method of FIG. 7 represents an example of a method of exchanging media data including: calculating a cumulative size of packets of a protocol data unit (PDU) Set received from a source device; determining a signaled size for the PDU Set; calculating a ratio between the cumulative size and the signaled size; and sending data representative of the ratio to the source device.

Various examples of the techniques of this disclosure are summarized in the following clauses:

Clause 1: A method of exchanging media data, the method comprising: calculating a cumulative size of packets of a protocol data unit (PDU) Set received from a source device; determining a signaled size for the PDU Set; calculating a ratio between the cumulative size and the signaled size; and sending data representative of the ratio to the source device.

Clause 2: The method of clause 1, wherein sending the data representative of the ratio to the source device comprises: determining whether the ratio exceeds at least one threshold; and in response to determining that the ratio exceeds the at least one threshold, sending the data representative of the ratio to the source device.

Clause 3: The method of clause 2, further comprising receiving data defining the at least one threshold from the source device.

Clause 4: The method of clause 1, wherein sending the data representative of the ratio to the source device comprises: determining whether the ratio is within a defined range; and in response to determining that the ratio is not within the defined range, sending the data representative of the ratio to the source device.

Clause 5: The method of clause 4, further comprising receiving data defining the defined range from the source device.

Clause 6: The method of any of clauses 1-5, wherein sending the data representative of the ratio comprises sending a Session Description Protocol (SDP) update message to the source device.

Clause 7: The method of any of clauses 1-6, further comprising performing IP packet reassembly of the packets of the PDU Set, wherein calculating the cumulative size of the packets comprises calculating the cumulative size of the packets before performing the IP packet reassembly of the packets of the PDU Set.

Clause 8: The method of any of clauses 1-7, wherein the method is performed by a unit that performs OSI Model Layer 3 processing on packets, the method further comprising providing the ratio to an OSI Model Layer 7 processing unit.

Clause 9: The method of clause 8, wherein the OSI Model Layer 7 processing unit comprises a Media Session Handler (MSH).

Clause 10: The method of any of clauses 1-7, wherein the method is performed by a unit of a last access network node that also performs IP packet reassembly, the method further comprising sending reassembled IP packets for the PDU Set to a destination device, wherein sending the data representative of the ratio to the source device comprises sending the data representative of the ratio to the destination device to cause the destination device to send the data representative of the ratio to the source device.

Clause 11: The method of clause 10, wherein the PDU Set comprises a first PDU set, the method further comprising, for a plurality of other PDU Sets: calculating cumulative sizes of packets of the other PDU Sets received from the source device; determining signaled sizes for the other PDU Sets; calculating ratios between the cumulative sizes and the corresponding signaled sizes; and sending data representative of the ratios to the destination device to cause the destination device to send the data representative of the ratios to the source device.

Clause 12: The method of any of clauses 10 and 11, wherein sending the data representative of the ratios to the destination device comprises sending one or more of a radio resource control (RRC) message, a MAC control element (MAC CE) message, a downlink control information (DCI) message, or a MAC layer management message to the destination device.

Clause 13: A method of exchanging media data, the method comprising: determining, by a device in a local network, a destination device IP address type for packets of a protocol data unit (PDU) Set received from a source device for which IP fragmentation is not performed and a router IP address type used by a router of the local network; and sending, to the source device, data representative of the destination device IP address type and the router IP address type.

Clause 14: The method of clause 13, wherein the method is performed by a device executing an Application Function (AF).

Clause 15: The method of any of clauses 13 and 14, wherein sending the data representative of the destination device IP address type and the router IP address type comprises sending the data representative of the destination device IP address type and the router IP address type to a destination device to cause the destination device to send the data representative of the destination device IP address type and the router IP address type to the source device.

Clause 16: The method of clause 13, wherein the method is performed by a destination device that is a destination for the PDU Set.

Clause 17: The method of any of clauses 13-16, wherein the router executes a user plane function (UPF).

Clause 18: The method of any of clauses 13-17, wherein the source device comprises an Application Server (AS).

Clause 19: The method of any of clauses 13-18, wherein sending the data representative of the public IP address type comprises sending a Session Description Protocol (SDP) message to the source device.

Clause 20: A method of exchanging media data, the method comprising: sending a first protocol data unit (PDU) Set size (PSSize) associated with a first PDU Set to a destination device; sending the first PDU Set to the destination device; receiving, from the destination device, data representing a ratio between a cumulative packet size for received packets of the first PDU Set and the first PSSize; calculating a second PSSize associated with a second PDU Set according to the first PSSize and the ratio; sending the second PSSize to the destination device; and sending the second PDU Set to the destination device.

Clause 21: A method of exchanging media data, the method comprising: sending a first protocol data unit (PDU) Set size (PSSize) associated with a first PDU Set to a destination device; sending the first PDU Set to the destination device; receiving data representative of a destination device IP address type for the destination device and a router IP address type for a router of a network including the destination device; calculating a second PSSize associated with a second PDU Set according to the destination device IP address type and the router IP address type; sending the second PSSize to the destination device; and sending the second PDU Set to the destination device.

Clause 22: The method of clause 21, wherein calculating the second PSSize value comprises calculating the second PSSize according to: first PSSize+N*((router IP address type header size)−(destination device IP address type header size)), wherein N represents a number of packets included in the second PDU Set.

Clause 23: The method of clause 22, wherein the router IP address type header size is equal to: 20 bytes when the router IP address type is IPv4, or 40 bytes when the router IP address type is IPv6.

Clause 24: The method of any of clauses 22 and 23, wherein the destination device IP address type header size is equal to: 20 bytes when the destination device IP address type is IPv4, or 40 bytes when the destination device IP address type is IPv6.

Clause 25: A device for retrieving media data, the device comprising one or more means for performing the method of any of clauses 1-24.

Clause 26: The device of clause 25, wherein the one or more means comprise a processing system comprising one or more processors implemented in circuitry.

Clause 27: The device of clause 25, wherein the device comprises at least one of: an integrated circuit; a microprocessor; or a wireless communication device.

Clause 28: A computer-readable storage medium having stored thereon instructions that, when executed, cause a processing system to perform the method of any of clauses 1-24.

Clause 29: A device for exchanging media data, the device comprising: means for calculating a cumulative size of packets of a protocol data unit (PDU) Set received from a source device; means for determining a signaled size for the PDU Set; means for calculating a ratio between the cumulative size and the signaled size; and means for sending data representative of the ratio to the source device.

Clause 30: A device for exchanging media data coupled to a local network, the device comprising: means for determining a destination device IP address type for packets of a protocol data unit (PDU) Set received from a source device for which IP fragmentation is not performed and a router IP address type used by a router of the local network; and means for sending, to the source device, data representative of the destination device IP address type and the router IP address type.

Clause 31: A device for exchanging media data, the device comprising: means for sending a first protocol data unit (PDU) Set size (PSSize) associated with a first PDU Set to a destination device; means for sending the first PDU Set to the destination device; means for receiving, from the destination device, data representing a ratio between a cumulative packet size for received packets of the first PDU Set and the first PSSize; means for calculating a second PSSize associated with a second PDU Set according to the first PSSize and the ratio; means for sending the second PSSize to the destination device; and means for sending the second PDU Set to the destination device.

Clause 32: A device for exchanging media data, the device comprising: means for sending a first protocol data unit (PDU) Set size (PSSize) associated with a first PDU Set to a destination device; means for sending the first PDU Set to the destination device; means for receiving data representative of a destination device IP address type for the destination device and a router IP address type for a router of a network including the destination device; means for calculating a second PSSize associated with a second PDU Set according to the destination device IP address type and the router IP address type; means for sending the second PSSize to the destination device; and means for sending the second PDU Set to the destination device.

Clause 33: A method of exchanging media data, the method comprising: calculating a cumulative size of packets of a protocol data unit (PDU) Set received from a source device; determining a signaled size for the PDU Set; calculating a ratio between the cumulative size and the signaled size; and sending data representative of the ratio to the source device.

Clause 34: The method of clause 33, wherein sending the data representative of the ratio to the source device comprises: determining whether the ratio exceeds at least one threshold; and in response to determining that the ratio exceeds the at least one threshold, sending the data representative of the ratio to the source device.

Clause 35: The method of clause 34, further comprising receiving data defining the at least one threshold from the source device.

Clause 36: The method of clause 33, wherein sending the data representative of the ratio to the source device comprises: determining whether the ratio is within a defined range; and in response to determining that the ratio is not within the defined range, sending the data representative of the ratio to the source device.

Clause 37: The method of clause 36, further comprising receiving data defining the defined range from the source device.

Clause 38: The method of clause 33, wherein sending the data representative of the ratio comprises sending a Session Description Protocol (SDP) update message to the source device.

Clause 39: The method of clause 33, further comprising performing IP packet reassembly of the packets of the PDU Set, wherein calculating the cumulative size of the packets comprises calculating the cumulative size of the packets before performing the IP packet reassembly of the packets of the PDU Set.

Clause 40: The method of clause 33, wherein the method is performed by a unit that performs OSI Model Layer 3 processing on packets, the method further comprising providing the ratio to an OSI Model Layer 7 processing unit.

Clause 41: The method of clause 40, wherein the OSI Model Layer 7 processing unit comprises a Media Session Handler (MSH).

Clause 42: The method of clause 33, wherein the method is performed by a unit of a last access network node that also performs IP packet reassembly, the method further comprising sending reassembled IP packets for the PDU Set to a destination device, wherein sending the data representative of the ratio to the source device comprises sending the data representative of the ratio to the destination device to cause the destination device to send the data representative of the ratio to the source device.

Clause 43: The method of clause 42, wherein the PDU Set comprises a first PDU set, the method further comprising, for a plurality of other PDU Sets: calculating cumulative sizes of packets of the other PDU Sets received from the source device; determining signaled sizes for the other PDU Sets; calculating ratios between the cumulative sizes and the corresponding signaled sizes; and sending data representative of the ratios to the destination device to cause the destination device to send the data representative of the ratios to the source device.

Clause 44: The method of clause 33, wherein sending the data representative of the ratios to the destination device comprises sending one or more of a radio resource control (RRC) message, a MAC control element (MAC CE) message, a downlink control information (DCI) message, or a MAC layer management message to the destination device.

Clause 45: A method of exchanging media data, the method comprising: determining, by a device in a local network, a destination device IP address type for packets of a protocol data unit (PDU) Set received from a source device for which IP fragmentation is not performed and a router IP address type used by a router of the local network; and sending, to the source device, data representative of the destination device IP address type and the router IP address type.

Clause 46: The method of clause 45, wherein the method is performed by a device executing an Application Function (AF).

Clause 47: The method of clause 45, wherein sending the data representative of the destination device IP address type and the router IP address type comprises sending the data representative of the destination device IP address type and the router IP address type to a destination device to cause the destination device to send the data representative of the destination device IP address type and the router IP address type to the source device.

Clause 48: The method of clause 45, wherein the method is performed by a destination device that is a destination for the PDU Set.

Clause 49: The method of clause 45, wherein the router executes a user plane function (UPF).

Clause 50: The method of clause 45, wherein the source device comprises an Application Server (AS).

Clause 51: The method of clause 45, wherein sending the data representative of the public IP address type comprises sending a Session Description Protocol (SDP) message to the source device.

Clause 52: A method of exchanging media data, the method comprising: sending a first protocol data unit (PDU) Set size (PSSize) associated with a first PDU Set to a destination device; sending the first PDU Set to the destination device; receiving, from the destination device, data representing a ratio between a cumulative packet size for received packets of the first PDU Set and the first PSSize; calculating a second PSSize associated with a second PDU Set according to the first PSSize and the ratio; sending the second PSSize to the destination device; and sending the second PDU Set to the destination device.

Clause 53: A method of exchanging media data, the method comprising: sending a first protocol data unit (PDU) Set size (PSSize) associated with a first PDU Set to a destination device; sending the first PDU Set to the destination device; receiving data representative of a destination device IP address type for the destination device and a router IP address type for a router of a network including the destination device; calculating a second PSSize associated with a second PDU Set according to the destination device IP address type and the router IP address type; sending the second PSSize to the destination device; and sending the second PDU Set to the destination device.

Clause 54: The method of clause 53, wherein calculating the second PSSize value comprises calculating the second PSSize according to: first PSSize+N*((router IP address type header size)−(destination device IP address type header size)), wherein N represents a number of packets included in the second PDU Set.

Clause 55: The method of clause 54, wherein the router IP address type header size is equal to: 20 bytes when the router IP address type is IPv4, or 40 bytes when the router IP address type is IPv6.

Clause 56: The method of clause 54, wherein the destination device IP address type header size is equal to: 20 bytes when the destination device IP address type is IPv4, or 40 bytes when the destination device IP address type is IPv6.

Clause 57: A method of exchanging media data, the method comprising: calculating a cumulative size of packets of a protocol data unit (PDU) Set received from a source device; determining a signaled size for the PDU Set; calculating a ratio between the cumulative size and the signaled size; and sending data representative of the ratio to the source device.

Clause 58: The method of clause 57, further comprising determining to send the data representative of the ratio to the source device based on the ratio.

Clause 59: The method of clause 57, wherein sending the data representative of the ratio comprises: determining that the ratio exceeds at least one threshold; and in response to the determination that the ratio exceeds the at least one threshold, sending the data representative of the ratio to the source device.

Clause 60: The method of clause 59, further comprising receiving data defining the at least one threshold from the source device.

Clause 61: The method of clause 57, wherein sending the data representative of the ratio comprises: determining that the ratio is not within a defined range; and in response to the determination that the ratio is not within the defined range, sending the data representative of the ratio to the source device.

Clause 62: The method of clause 61, further comprising receiving data defining the defined range from the source device.

Clause 63: The method of clause 57, wherein the data representative of the ratio comprises data explicitly indicating the ratio.

Clause 64: The method of clause 57, wherein the data representative of the ratio comprises data indicating the amount by which the signaled size needs to be adjusted to achieve a target ratio between the cumulative size and the signaled size.

Clause 65: The method of clause 64, further comprising: determining that the amount by which the signaled size needs to be adjusted exceeds at least one threshold; and in response to the determination that the amount by which the signaled size needs to be adjusted exceeds the at least one threshold, sending the data representative of the amount by which the signaled size needs to be adjusted to the source device.

Clause 66: The method of clause 64, further comprising: determining that the amount by which the signaled size needs to be adjusted is not within a defined range; and in response to determining that the amount by which the signaled size needs to be adjusted is not within the defined range, sending the data representative of the amount by which the signaled size needs to be adjusted to the source device.

Clause 67: The method of clause 57, wherein sending the data representative of the ratio comprises sending a Session Description Protocol (SDP) update message to the source device.

Clause 68: The method of clause 57, further comprising performing IP packet reassembly of the packets of the PDU Set, wherein calculating the cumulative size of the packets comprises calculating the cumulative size of the packets before performing the IP packet reassembly of the packets of the PDU Set.

Clause 69: The method of clause 57, wherein the method is performed by a unit that performs OSI Model Layer 3 processing on packets, the method further comprising providing the ratio to a Media Session Handler (MSH).

Clause 70: The method of clause 57, wherein the method is performed by a unit of a last access network node that also performs IP packet reassembly, the method further comprising sending reassembled IP packets for the PDU Set to a destination device, wherein sending the data representative of the ratio to the source device comprises sending the data representative of the ratio to the destination device to cause the destination device to send the data representative of the ratio to the source device.

Clause 71: The method of clause 70, wherein the PDU Set comprises a first PDU set, the method further comprising, for a plurality of other PDU Sets: calculating cumulative sizes of packets of the other PDU Sets received from the source device; determining signaled sizes for the other PDU Sets calculating ratios between the cumulative sizes and the corresponding signaled sizes; and sending data representative of the ratios to the destination device to cause the destination device to send the data representative of the ratios to the source device.

Clause 72: The method of clauses 70, wherein sending the data representative of the ratios to the destination device comprises sending one or more of a radio resource control (RRC) message, a MAC control clement (MAC CE) message, a downlink control information (DCI) message, or a MAC layer management message to the destination device.

Clause 73: A device for retrieving media data, the device comprising: a memory configured to store media data; and a processing system implemented in circuitry, the processing system being configured to: calculate a cumulative size of packets of a protocol data unit (PDU) Set received from a source device; determine a signaled size for the PDU Set; calculate a ratio between the cumulative size and the signaled size; and send data representative of the ratio to the source device.

Clause 74: The device of clause 73, wherein to send the data representative of the ratio, the processing system is configured to: receive at least one threshold from the source device; and send the data representative of the ratio in response to determining that the ratio exceeds the at least one threshold.

Clause 75: The device of clause 73, wherein to send the data representative of the ratio, the processing system is configured to: receive data defining a defined range from the source device; and send the data representative of the ratio in response to determining that the ratio is not within the defined range.

Clause 76: A computer-readable storage medium having stored thereon instructions that, when executed, cause a processing system to: calculate a cumulative size of packets of a protocol data unit (PDU) Set received from a source device; determine a signaled size for the PDU Set; calculate a ratio between the cumulative size and the signaled size; and send data representative of the ratio to the source device.

Clause 77: A method of exchanging media data, the method comprising: calculating a cumulative size of packets of a protocol data unit (PDU) Set received from a source device; determining a signaled size for the PDU Set; calculating a ratio between the cumulative size and the signaled size; and sending data representative of the ratio to the source device.

Clause 78: The method of clause 77, further comprising determining to send the data representative of the ratio to the source device based on the ratio.

Clause 79: The method of clause 77, wherein sending the data representative of the ratio comprises: determining that the ratio exceeds at least one threshold; and in response to the determination that the ratio exceeds the at least one threshold, sending the data representative of the ratio to the source device.

Clause 80: The method of clause 79, further comprising receiving data defining the at least one threshold from the source device.

Clause 81: The method of clause 77, wherein sending the data representative of the ratio comprises: determining that the ratio is not within a defined range; and in response to the determination that the ratio is not within the defined range, sending the data representative of the ratio to the source device.

Clause 82: The method of clause 81, further comprising receiving data defining the defined range from the source device.

Clause 83: The method of clause 77, wherein the data representative of the ratio comprises data explicitly indicating the ratio.

Clause 84: The method of clause 77, wherein the data representative of the ratio comprises data indicating the amount by which the signaled size needs to be adjusted to achieve a target ratio between the cumulative size and the signaled size.

Clause 85: The method of clause 84, further comprising: determining that the amount by which the signaled size needs to be adjusted exceeds at least one threshold; and in response to the determination that the amount by which the signaled size needs to be adjusted exceeds the at least one threshold, sending the data representative of the amount by which the signaled size needs to be adjusted to the source device.

Clause 86: The method of clause 84, further comprising: determining that the amount by which the signaled size needs to be adjusted is not within a defined range; and in response to determining that the amount by which the signaled size needs to be adjusted is not within the defined range, sending the data representative of the amount by which the signaled size needs to be adjusted to the source device.

Clause 87: The method of clause 77, wherein sending the data representative of the ratio comprises sending a Session Description Protocol (SDP) update message to the source device.

Clause 88: The method of clause 87, wherein the SDP update message is included in a session initiation protocol (SIP) re-INVITE message.

Clause 89: The method of clause 87, wherein the SDP update message is included in a JavaScript Session Establishment Protocol (JSEP) message.

Clause 90: The method of clause 87, wherein the SDP update message is included in a Simple WebRTC Application Protocol (SWAP) message.

Clause 91: The method of clause 77, wherein sending the data representative of the ratio comprises sending a Simple WebRTC Application Protocol (SWAP) message.

Clause 92: The method of clause 91, wherein sending the SWAP message comprises sending a SWAP “application” message including a target parameter representing an identifier of the source device, a type value, and a fractional value representative of the ratio.

Clause 93: The method of clause 92, wherein the type value comprises “3gpp-release19-PSSize-correction-ratio.”

Clause 94: The method of clause 91, further comprising receiving a SWAP “application” acknowledgement message from the source device.

Clause 95: The method of clause 91, wherein sending the SWAP message comprises sending a SWAP PSSize correction message including a target parameter representing an identifier of the source device and a fractional value representative of the ratio.

Clause 96: The method of clause 77, further comprising performing IP packet reassembly of the packets of the PDU Set, wherein calculating the cumulative size of the packets comprises calculating the cumulative size of the packets before performing the IP packet reassembly of the packets of the PDU Set.

Clause 97: The method of clause 77, wherein the method is performed by a unit that performs OSI Model Layer 3 processing on packets, the method further comprising providing the ratio to a Media Session Handler (MSH).

Clause 98: The method of clause 77, wherein the method is performed by a unit of a last access network node that also performs IP packet reassembly, the method further comprising sending reassembled IP packets for the PDU Set to a destination device, wherein sending the data representative of the ratio to the source device comprises sending the data representative of the ratio to the destination device to cause the destination device to send the data representative of the ratio to the source device.

Clause 99: The method of clause 98, wherein the PDU Set comprises a first PDU set, the method further comprising, for a plurality of other PDU Sets: calculating cumulative sizes of packets of the other PDU Sets received from the source device; determining signaled sizes for the other PDU Sets; calculating ratios between the cumulative sizes and the corresponding signaled sizes; and sending data representative of the ratios to the destination device to cause the destination device to send the data representative of the ratios to the source device.

Clause 100: The method of clauses 98, wherein sending the data representative of the ratios to the destination device comprises sending one or more of a radio resource control (RRC) message, a MAC control element (MAC CE) message, a downlink control information (DCI) message, or a MAC layer management message to the destination device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of exchanging media data, the method comprising:
calculating a cumulative size of packets of a protocol data unit (PDU) Set received from a source device;
determining a signaled size for the PDU Set;
calculating a ratio between the cumulative size and the signaled size; and
sending data representative of the ratio to the source device.

2. The method of claim 1, further comprising determining to send the data representative of the ratio to the source device based on the ratio.

3. The method of claim 1, wherein sending the data representative of the ratio comprises:
determining that the ratio exceeds at least one threshold; and
in response to the determination that the ratio exceeds the at least one threshold, sending the data representative of the ratio to the source device.

4. The method of claim 3, further comprising receiving data defining the at least one threshold from the source device.

5. The method of claim 1, wherein sending the data representative of the ratio comprises:
determining that the ratio is not within a defined range; and
in response to the determination that the ratio is not within the defined range, sending the data representative of the ratio to the source device.

6. The method of claim 5, further comprising receiving data defining the defined range from the source device.

7. The method of claim 1, wherein the data representative of the ratio comprises data explicitly indicating the ratio.

8. The method of claim 1, wherein the data representative of the ratio comprises data indicating an amount by which the signaled size needs to be adjusted to achieve a target ratio between the cumulative size and the signaled size.

9. The method of claim 8, further comprising:
determining that the amount by which the signaled size needs to be adjusted exceeds at least one threshold; and
in response to the determination that the amount by which the signaled size needs to be adjusted exceeds the at least one threshold, sending the data representative of the amount by which the signaled size needs to be adjusted to the source device.

10. The method of claim 8, further comprising:
determining that the amount by which the signaled size needs to be adjusted is not within a defined range; and
in response to determining that the amount by which the signaled size needs to be adjusted is not within the defined range, sending the data representative of the amount by which the signaled size needs to be adjusted to the source device.

11. The method of claim 1, wherein sending the data representative of the ratio comprises sending a Session Description Protocol (SDP) update message to the source device.

12. The method of claim 1, further comprising performing IP packet reassembly of the packets of the PDU Set, wherein calculating the cumulative size of the packets comprises calculating the cumulative size of the packets before performing the IP packet reassembly of the packets of the PDU Set.

13. The method of claim 1, wherein the method is performed by a unit that performs OSI Model Layer 3 processing on packets, the method further comprising providing the ratio to a Media Session Handler (MSH).

14. The method of claim 1, wherein the method is performed by a unit of a last access network node that also performs IP packet reassembly, the method further comprising sending reassembled IP packets for the PDU Set to a destination device, wherein sending the data representative of the ratio to the source device comprises sending the data representative of the ratio to the destination device to cause the destination device to send the data representative of the ratio to the source device.

15. The method of claim 14, wherein the PDU Set comprises a first PDU set, the method further comprising, for a plurality of other PDU Sets:
calculating cumulative sizes of packets of the other PDU Sets received from the source device;
determining signaled sizes for the other PDU Sets;
calculating ratios between the cumulative sizes and the corresponding signaled sizes; and
sending data representative of the ratios to the destination device to cause the destination device to send the data representative of the ratios to the source device.

16. The method of claim 14, wherein sending the data representative of the ratios to the destination device comprises sending one or more of a radio resource control (RRC) message, a MAC control element (MAC CE) message, a downlink control information (DCI) message, or a MAC layer management message to the destination device.

17. A device for retrieving media data, the device comprising:
a memory configured to store media data; and
a processing system implemented in circuitry, the processing system being configured to:
calculate a cumulative size of packets of a protocol data unit (PDU) Set received from a source device;
determine a signaled size for the PDU Set;
calculate a ratio between the cumulative size and the signaled size; and
send data representative of the ratio to the source device.

18. The device of claim 17, wherein to send the data representative of the ratio, the processing system is configured to:
receive at least one threshold from the source device; and
send the data representative of the ratio in response to determining that the ratio exceeds the at least one threshold.

19. The device of claim 17, wherein to send the data representative of the ratio, the processing system is configured to:
receive data defining a defined range from the source device; and
send the data representative of the ratio in response to determining that the ratio is not within the defined range.

20. A computer-readable storage medium having stored thereon instructions that, when executed, cause a processing system to:
calculate a cumulative size of packets of a protocol data unit (PDU) Set received from a source device;
determine a signaled size for the PDU Set;
calculate a ratio between the cumulative size and the signaled size; and
send data representative of the ratio to the source device.
